(19) United States
(12) Patent Application Publication
(10) Pub. No.: US 2025/0177948 A1
(43) Pub. Date: Jun. 5, 2025

(54) A MASSIVE PARALLEL PLASMA REACTOR ARRAY FOR GAS CONVERSION APPLICATIONS

(71) Applicant: D-CRBN BV, Antwerp (BE)

(72) Inventors: Georgi TRENCHEV, Antwerp (BE); Gill SCHELTJENS, Wilrijk (BE); David ZIEGLER, Antwerp (BE)

(21) Appl. No.: 18/845,347

(22) PCT Filed: Mar. 10, 2023
(86) PCT No.: PCT/EP2023/056119

§ 371 Date: Sep. 9, 2024

(30) Foreign Application Priority Data
Mar. 11, 2022 (BE) BE2022/5170

(51) Int. Cl. B01J 19/24; B01J 19/08

(52) U.S. Cl. CPC B01J 19/2445; B01J 19/088; B01J 2219/0002; B01J 2219/0809; B01J 2219/0869; B01J 2219/0875; B01J 2219/0894; B01J 2219/1923

(57) ABSTRACT

The current invention relates to a reactor module for converting chemical compounds into materials, gases or energy, wherein the reactor module is suitable for contiguous radial stacking, comprising: a reaction chamber and at least one inlet pressure chamber, wherein at least one tangential flow channel, connected to said inlet pressure chamber, wherein said tangential flow channel is further connected to the reaction chamber tangentially to its circular cross-section, wherein said tangential channel is suitable for directing the flow of reactant gas into the reaction chamber. The invention also relates to a reactor stack comprising two or more reactor modules contiguously stacked in the radial plane. The invention also relates to the use of aforementioned module or a stack of modules for gas conversion.

### FIELD OF THE INVENTION

The present invention relates to a reactor module for converting chemical compounds into materials, gases or energy.

In a second aspect, the present invention also relates to a reactor stack comprising two or more reactor modules contiguously stacked.

In another aspect, the present invention also relates to a use of aforementioned module or reactor stack for gas conversion.

### BACKGROUND

Plasma reactors, thermal or combustion chambers are used to convert chemical compounds into materials, gases or energy. Atmospheric plasma reactors show promising performance for gas conversion applications and other material treatments. For industrial upscaling, certain challenges are faced in the sense of maintaining critical plasma parameters. In order to fulfil performance criteria, these devices need certain optimizations, which lead to complex geometrical structures, and/or addition of elements such as catalysts and co-reactants. Due to specific constraints, linear upscaling of these devices or reactors may be costly or simply not feasible.

Plasma reactors are known, for example from U.S. Pat. No. 7,919,053B2. However, this known reactor is not suited for linear upscaling.

KR20100055884 relates to a plasma reactor, and more particularly to a plasma reactor having a number of plasma reactors for uniform formation of a plasma reaction.

US20030175181 relates to an apparatus in which a plasma is generated in a reaction chamber for promoting the reaction in a gaseous medium supplied to the reaction chamber.

WO2022029663 describes methods and apparatus for stimulating chemical plasma reactions with nanosecond pulse electric discharge in the presence of a gas stream.

The present invention aims to resolve at least some of the problems and disadvantages mentioned above.

### SUMMARY OF THE INVENTION

The present invention and embodiments thereof serve to provide a solution to one or more of above-mentioned disadvantages. To this end, the present invention relates to a reactor module for converting chemical compounds into materials, gases or energy according to claim 1.

Preferred embodiments of the device are shown in any of the claims 2 to 7.

In a second aspect, the present invention relates to a reactor stack according to claim 8.

Preferred embodiments of the method are shown in any of the claims 9 and 10.

In a third aspect the present invention relates to a use of aforementioned reactor module or reactor stack for gas conversion according to claim 11.

Preferred embodiments of the method are shown in any of the claims 12 and 13.

It is a prime objective of the present invention to overcome abovementioned disadvantages of the prior art by setting multiple low-capacity reactors with pre-defined plasma parameters in a massive array. The main array body serves as an anode plate and a gas distribution network. In that sense, singular gas inlet and outlet are foreseen on the device. Each individual reactor is equipped with a vortex flow stabilization.

### DESCRIPTION OF FIGURES

The following numbering refers to:
1 Reactor module
2 Reaction chamber
3 Reactant inlet
4 Circular cross-section of reaction chamber
5 Radial plane
6 Axial direction
7 Tangential channel
8 First electrode (anode)
9 Second electrode (cathode cap)
10 Insulation ring
11 Stepped insert
12 Distance between anode and cathode
13 Reactor stack
14 Anode plate
15 Common inlet pressure chamber
16 Distal side of reactor stack
17 Pressure chamber inlet
18 Exhaust or outlet
19 Common exhaust
20 Proximal side of reactor stack
21 Common inlet pressure chamber
22 Catalysts and/or co-reactants

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows a perspective view of a reactor module according to an embodiment of the present invention.

FIG. 2 shows a perspective view of a reactor module according to an embodiment of the present invention.

FIG. 3 shows a perspective view of a reactor module with cathode cap according to an embodiment of the present invention.

FIG. 4 shows an enlarged view of a reaction chamber according to an embodiment of the present invention.

FIG. 5 shows a perspective view of a reactor stack according to an embodiment of the present invention.

FIG. 6 shows a perspective view of a reactor stack according to an embodiment of the present invention.

FIG. 7 shows a computational mesh for a flow simulation of a reactor stack according to an embodiment of the present invention.

FIG. 8 shows a transparent perspective view of a reactor stack with inlet pressure chamber according to an embodiment of the present invention.

FIG. 9 shows a top view of simulation results for the flow velocity streamlines in a 2×2 reactor stack with a central pressure chamber inlet, according to an embodiment of the present invention.

FIG. 10 shows a perspective view of simulation results for the flow velocity streamlines in a 2×2 reactor stack with a central pressure chamber inlet, according to an embodiment of the present invention.

FIG. 11 shows flow side view of simulation results for the flow velocity streamlines in a 2×2 reactor stack with a central pressure chamber inlet, according to an embodiment of the present invention.

FIG. 12 shows a top view of a reactor stack with 5 (12A), 6 (12B), 7 (12C), and 21 (12D) reactor modules, wherein the reaction chambers of the reactor modules form a square (12A), hexagonal (12B, 12C), or extended hexagonal (12D) pattern according to an embodiment of the present invention.

FIG. 13 shows a cross-sectional view of a radial reactor stack of 4 reactor modules implemented in a plasma reactor according to an embodiment of the present invention.

FIG. 14 shows a perspective view of a reactor stack with four reactor modules provided with interchangeable outlet nozzles according to an embodiment of the present invention.

FIG. 15 shows a computational mesh for a flow simulation (CFD simulation) of the reactor stack shown in FIG. 14.

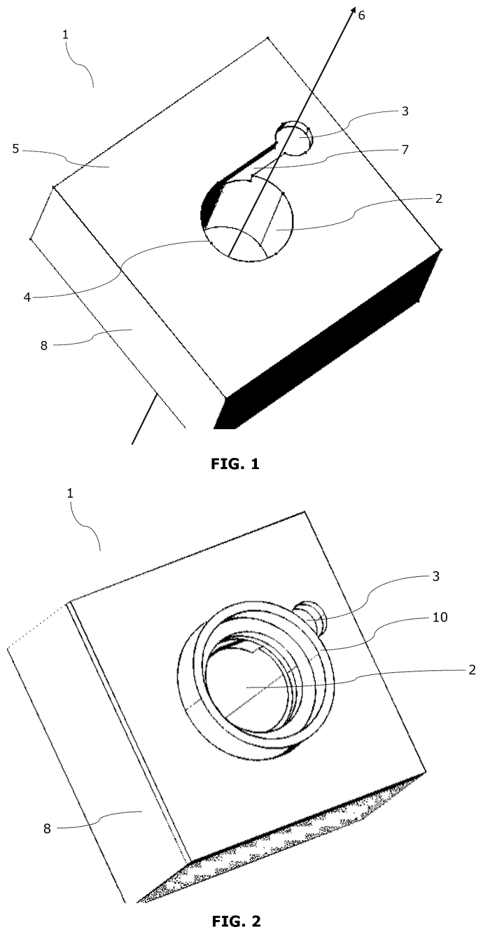

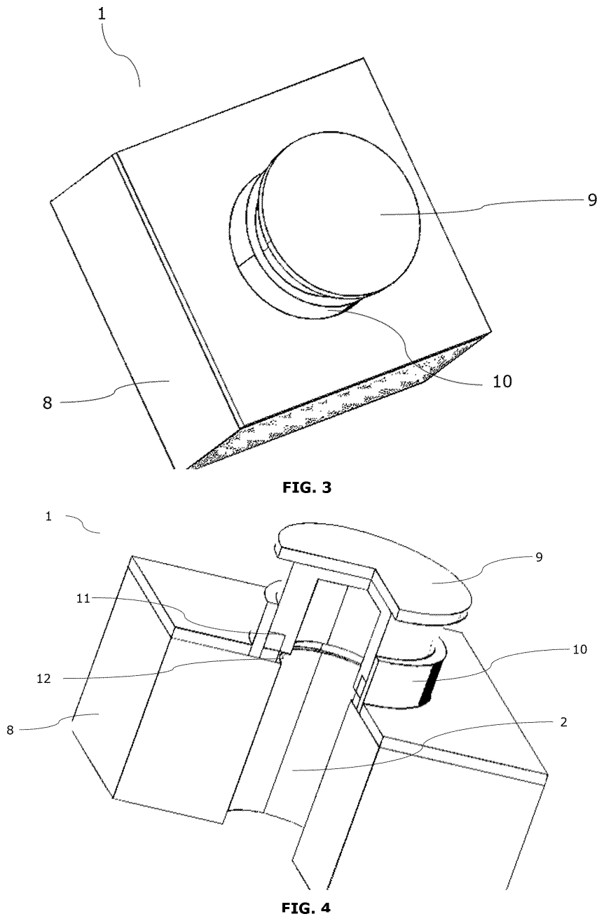

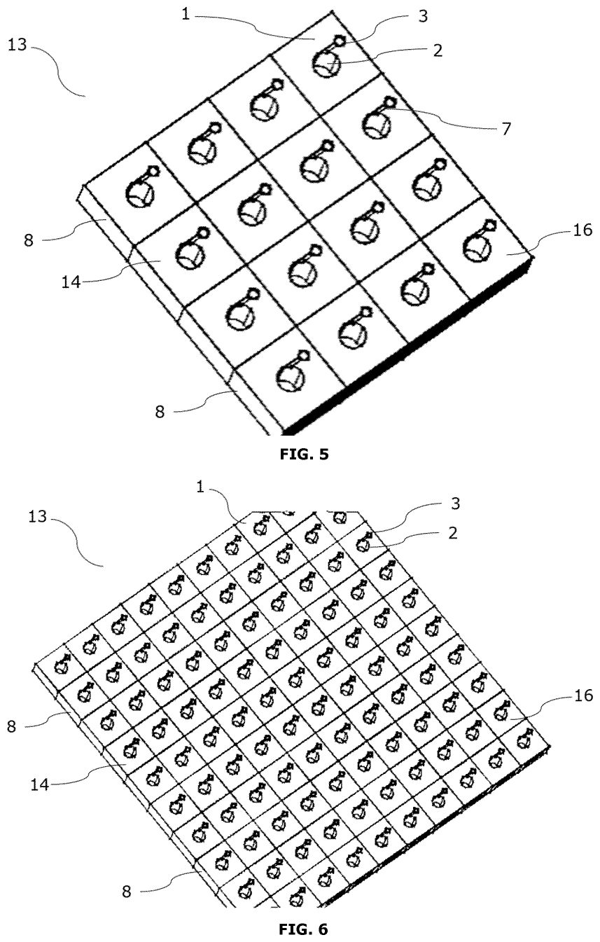

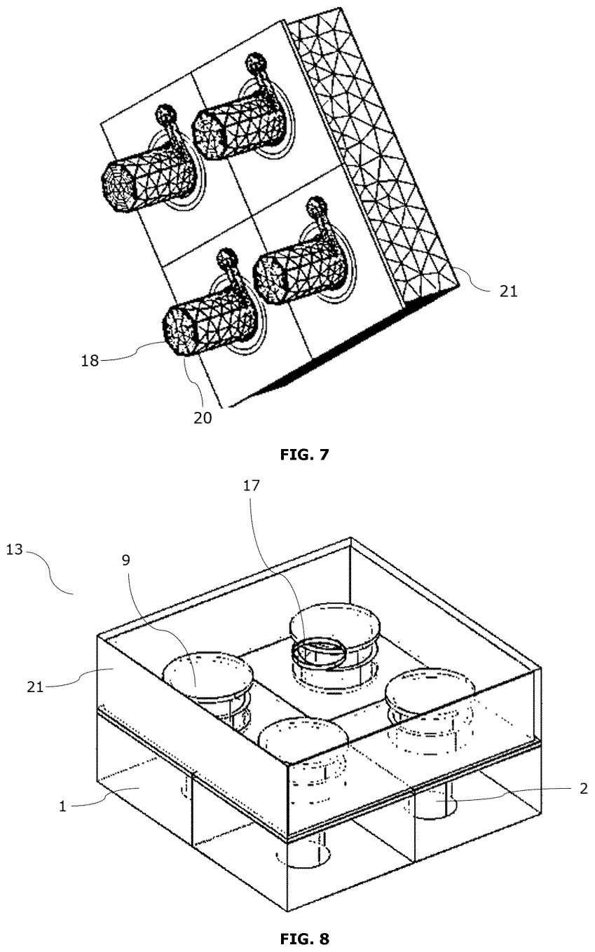

### DETAILED DESCRIPTION OF THE INVENTION

The present invention concerns a reactor for converting chemical compounds into materials, gases or energy.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The expressions “gliding arc (GA)”, “glow discharge”, “radiofrequency plasma (RF)”, “microwave plasma (MW)”, “inductively coupled plasma (ICP)”, “capacitive coupled plasma (CCP)” and “dielectric barrier discharge (DBD)”, as used in the text, refer to plasma generating means as would be understood by those in the art.

In a first aspect, the invention relates to a reactor module for converting chemical compounds into materials, gases or energy, wherein the reactor module is suitable for contiguous radial stacking.

In a particularly preferred embodiment of the invention, the reactor module comprises:
a reaction chamber, wherein the reaction chamber has a cylindrical shape characterized by a circular cross-section, wherein said circular cross-section lies in a radial plane, wherein the reaction chamber extends in the axial direction perpendicular to said radial plane;
at least one reactant inlet;

In this embodiment of the invention, the reactor module further comprises at least one tangential flow channel, in fluid communication to said reactant inlet, wherein said tangential flow channel is further connected to the reaction chamber tangentially to its circular cross-section, wherein said tangential channel is suitable for directing the flow of reactant gas into the reaction chamber.

The tangential flow channel is suitable as a swirl generator for the gas flow. The tangential channel will allow the gas to enter the reaction chamber tangentially, where it forms a forward or a reverse vortex flow pattern. This pattern is known to improve the discharge efficiency and stability.

The reactor module of the current invention is suitable to be used as sole reactor or in a combination with similar reactor modules in a radial stack.

Said reaction chamber has a cylindrical shape characterized by a circular cross-section preferably with a diameter of 10-200 mm, more preferably with a diameter of 20-60 mm, even more preferably with a diameter of 25 mm.

In a preferred embodiment of the invention, the reaction chamber is connected to an exhaust, preferably said exhaust is suitable to be connected to a common exhaust.

In a preferred embodiment of the invention, the reaction chamber is connected to an exhaust, preferably said exhaust is suitable to be connected to a common exhaust.

Preferably, said exhaust channel is suitable to be connected to a common exhaust when the reactor module is contiguously stacked in the radial plane.

The expressions “exhaust” and “outlet”, as used herein, are to be regarded as synonyms.

In a preferred embodiment of the invention, the reaction chamber is produced from a first electrode and wherein each reaction chamber is further provided with a second electrode.

In this embodiment of the invention, said second electrode is separated from the first electrode with an insulation ring.

In a more preferred embodiment of the invention, the second electrode has the form of a cap and is configured as cathode. Preferably, the insulation ring features a stepped insert matching the radius of the cathode cap. In this way, it keeps the cathode at a certain distance from the anode for efficient discharge ignition, preferably 0.5-5 mm, more preferably 1-3 mm, even more preferably 2 mm. This start-up gap may be modified by preference, in order to support higher or lower ignition voltage, or alternatively higher or lower flow rates (higher flow rates will typically increase the start-up voltage).

In a preferred embodiment of the invention, said second electrode extends axially from said reaction chamber.

In a preferred embodiment of the invention, the reaction chambers comprise plasma generating means, said means chosen from the list of:
gliding arc (GA)
glow discharge
radiofrequency plasma (RF)
microwave plasma (MW)
inductively coupled plasma (ICP)
capacitive coupled plasma (CCP)
dielectric barrier discharge (DBD).

In a more preferred embodiment of the invention, the reaction chambers comprise plasma generating means, said means chosen from the list of:
gliding arc (GA)
glow discharge
radiofrequency plasma (RF)
microwave plasma (MW).

In an even more preferred embodiment of the invention, the reaction chambers comprise plasma generating means, said means being gliding arc (GA).

In a preferred embodiment of the invention, the reactor module further comprises one or more heat exchange channels suitable for fluid flow therethrough.

In a preferred embodiment of the invention, the reactor module has a cuboid shape, preferably a cubic shape.

In a preferred embodiment of the invention, the proximal side of the reaction chamber is provided with an outlet nozzle at the exhaust or outlet. The outlet nozzle downsizes the diameter of the exhaust to the diameter of the outlet nozzle. This nozzle diameter can be 10-200 mm, more preferably 20-60 mm, even more preferably 1-25 mm, even more preferably 1-20 mm, such as 7, 12 or 18 mm. The nozzle diameter is preferably smaller than the diameter of the reaction chamber.

In a further preferred embodiment, the outlet nozzles are removable and replaceable, preferably interchangeable between different reactor modules.

The inventors have found that the outlet nozzles increase the reverse vortex flow pattern. Furthermore, it provides strong rotation and ability to center and stabilize the plasma.

In a second aspect, the invention relates to a reactor stack comprising two or more aforementioned reactor modules contiguously stacked in the radial plane.

In a preferred embodiment of the invention, the reactor stack comprises two or more identical aforementioned reactor modules contiguously stacked in the radial plane.

In an embodiment of the invention, said two or more reactor modules are stacked according to two perpendicular axial axes.

In an embodiment of the invention, the reactor stack comprises a common inlet pressure chamber.

In a preferred embodiment of the invention, each reactant inlet of each reactor module is in fluid communication with a common inlet pressure chamber, preferably said common inlet pressure chamber extends radially.

In a preferred embodiment of the invention, each reaction chamber of each reactor module is in fluid communication with a single outlet extending in the radial plane.

In an embodiment of the invention, the amount of reactor modules in the reactor stack is a square.

The reactor stack comprises preferably between 4 and 1000 reactor modules, more preferably between 20 and 100 reactor modules, even more preferably between 40 and 60 reactor modules.

In an embodiment of the invention, the reactor stack forms a n×n reactor array, wherein n is a number chosen from the list of 2, 3, 4, 5, 6, 7, 8, 9 or 10 preferably chosen from the list of 5, 6, 7 or 8.

In another embodiment of the invention, the reactor modules in the reactor stack form a regular pattern, preferably a regular polygon pattern, such as a square or hexagonal pattern.

In this embodiment, the reaction chambers in the reactor stack form a regular pattern, preferably a regular polygon pattern, such as a square or hexagonal pattern.

The inventors have found that these patterns optimize the heat dissipation and minimize the electromagnetic interference between the reactor modules.

Preferably, the individual reactor modules may be fused together in an anode plate, or equivalently, machined in one uni-body metal (or otherwise conductive) plate.

The reactor stack body, formed by the individual reactor modules, serves as an anode plate and a gas distribution network. Preferably, singular gas inlet and outlet are foreseen on the reactor stack. Each individual reactor module is equipped with a vortex flow stabilization.

In a preferred embodiment of the invention, the proximal side of the reaction chambers of the reactor modules in the reactor stack are provided with an outlet nozzle at the exhaust or outlet. The outlet nozzle downsizes the diameter of the exhaust to the diameter of the outlet nozzle. This nozzle diameter can be 10-200 mm, more preferably 20-60 mm, even more preferably 1-25 mm, even more preferably 1-20 mm, such as 7, 12 or 18 mm. The nozzle diameter is preferably smaller than the diameter of the reaction chamber. It is possible that the reactor modules in the reactor stack are provided with outlet nozzles with different nozzle diameters. It is also possible that only a fraction of the reactor modules in the reactor stack is provided with such outlet nozzles.

In a further preferred embodiment, the outlet nozzles are removable and replaceable, preferably interchangeable between the reactor modules.

The inventors have found that the outlet nozzles increase the reverse vortex flow pattern. Furthermore, it provides strong rotation and ability to center and stabilize the plasma.

In a third aspect, the invention relates to a use of aforementioned reactor module or aforementioned stack of modules for gas conversion.

In a preferred embodiment, the gas may be flue gas, waste gas from combustion, CO₂, CO, CH₄, H₂, and/or any combinations thereof, including impurities such as H₂O and SO₂.

In a more preferred embodiment of the invention, the gas comprises more than 98% CO₂ by weight. In another preferred embodiment of the invention, the gas comprises CO₂ and CH₄ in a ratio by weight of at most 4/1, more preferably at most 3/1, more preferably at most 2/1, more preferably at most 1/1. In another preferred embodiment of the invention, the gas comprises CO₂ and CH₄ in a ratio by weight of at least 1/4, more preferably at least 1/3, more preferably at least 1/2, more preferably at least 1/1. In another embodiment, the gas comprises CO₂ and CH₄ in a ratio between 4/1 and 1/4, more preferably in a ratio between 3/1 and 1/3, more preferably in a ratio between 2/1 and 1/2, most preferably in a ratio of about 1/1.

In a preferred embodiment of the invention, the gas conversion is carried out by plasma generation in the one or more reaction chambers.

In a particularly preferred embodiment, the gas comprises CO₂.

In this embodiment of the invention, the plasma is generated by a plasma generating means chosen from the list of:
gliding arc (GA)
glow discharge
radiofrequency plasma (RF)
microwave plasma (MW)
inductively coupled plasma (ICP)
capacitive coupled plasma (CCP)
dielectric barrier discharge (DBD).

Preferably, the plasma is generated by a plasma generating means chosen from the list of:
gliding arc (GA)
glow discharge
radiofrequency plasma (RF)
microwave plasma (MW).

More preferably, the plasma is generated by a plasma generating means, said means being gliding arc (GA).

In an another particularly preferred embodiment, the gas comprises CH₄.

In this embodiment of the invention, the plasma is generated by a plasma generating means chosen from the list of:
glow discharge
gliding arc (GA)
dielectric barrier discharge (DBD)
microwave plasma (MW)
radiofrequency plasma (RF)
inductively coupled plasma (ICP)
capacitive coupled plasma (CCP).

Preferably, the plasma is generated by a plasma generating means chosen from the list of:
glow discharge
gliding arc (GA)
dielectric barrier discharge (DBD)
microwave plasma (MW).

More preferably, the plasma is generated by a plasma generating means, said means being glow discharge.

In this embodiment, the gas comprises CH₄, wherein the CH₄ converted to syngas and/or H₂.

In a preferred embodiment of the invention, the flow rate of the reactant gas in each reaction chamber is comprised between 0.5 and 5000 L/min, preferably between 1 and 100 L/min, more preferably between 10-50 L/min.

In an embodiment of the invention, each reactor module may be operated at a power value of 0.1-100 kW, preferably each reactor module may be operated at a power value of 1-10 kW, more preferably each reactor module may be operated at a power value of 1 kW.

Gliding arc (GA) and glow discharge plasma generating means can be powered by AC, AC pulsed, DC pulsed and DC power supplies with a linear or switching conversion topology.

DBD, ICP, RF and MW plasma generating means can be powered via the means of a solid-state generator coupled with a high-frequency amplifier, or, alternatively, by a magnetron (MW).

The invention is further described by the following non-limiting examples which further illustrate the invention, and are not intended to, nor should they be interpreted to, limit the scope of the invention.

### EXAMPLES AND/OR DESCRIPTION OF FIGURES

With as a goal illustrating better the properties of the invention the following presents, as an example and limiting in no way other potential applications, a description of a number of preferred applications of the method for examining the state of the grout used in a mechanical connection based on the invention, wherein:

In an embodiment of the present invention, a reactor module 1 with cubic shape has a central reaction chamber 2 and a reactant inlet 3, parallel to the reaction chamber 2. The reaction chamber 2 has a cylindrical shape characterized by a circular cross-section 4, wherein said circular cross-section lies in a radial plane 5 and wherein the reaction chamber 2 extends in the axial direction 6 perpendicular to said radial plane 5. The reactor module 1 is cubic shaped with a surface area of 360 mm².

The reactor module 1 has one tangential flow channel 7, connected to the reactant inlet 3 and to the reaction chamber 2 tangentially to its circular cross-section 4.

The reaction chamber 2 is produced from a first electrode 8, configured to serve as an anode, and is provided with a second electrode 9, in the form of a cathode cap. The reaction chamber 2 is separated from the second electrode 9 with an insulation ring 10. The second electrode 9 extends axially 6 from the reaction chamber 2.

The insulation ring 10 features a stepped insert 11 matching the radius of the cathode cap 9. In this way, it keeps the cathode 9 at a certain distance 12 from the anode 8, for efficient discharge ignition.

In an embodiment of the present invention, the reactor stack 13 consists of sixteen reactor modules 1 contiguously stacked in the radial plane 5. The anode bodies 8 of the individual reactor modules 1 are fused together in the anode plate 14.

A common inlet pressure chamber 15 can extend over the distal side 16 of the reactor stack 13, wherein each reactant inlet 3 is fluidly connected to said common inlet pressure chamber. The common inlet pressure chamber 21 has a central pressure chamber inlet 17. Each reactor module 1 has an exhaust or outlet 18, which is connected to a common exhaust 19 that extends over the proximal side 20 of the reactor stack 13. The common exhaust 19 is supplied with catalysts 22.

The present invention will now be further exemplified with reference to the following examples. The present invention is in no way limited to the given examples or to the embodiments presented in the figures.

### Example 1: Flow Calculation of Reactant Gas and Product Gas

Example 1 refers to a flow calculation performed on a reactor stack according to an embodiment of the present invention. Results show that the flow velocity varies between 5 and 40 m/s. Also, the vortex flow streamlines in the reaction chambers are calculated.

The flow pattern reveals the gas distribution and vortex formation in the reaction chambers.

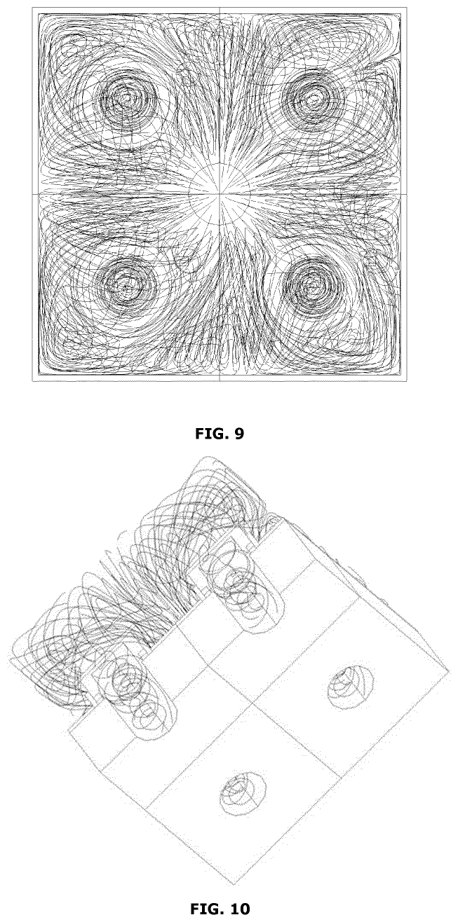

To better exemplify reference is made to FIGS. 9 and 10 which show simulation results for the flow velocity streamlines in a 2×2 reactor stack with a central pressure chamber inlet, according to an embodiment of the present invention, in a top view (FIG. 9) and a perspective view (FIG. 10). The single inlet redistributes gas flow amongst the four reactor modules, resulting in parallel operation.

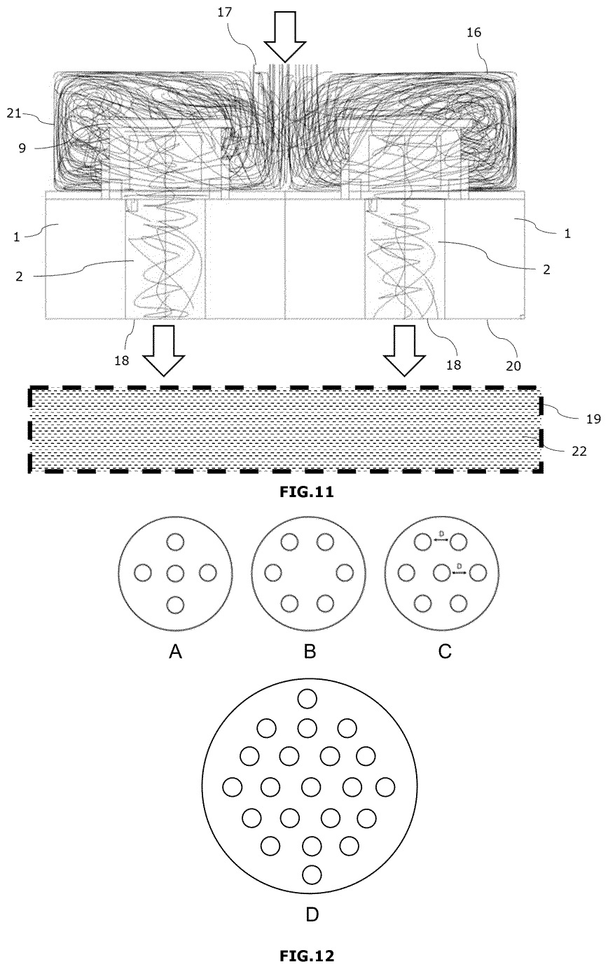

As shown in FIG. 11, additional co-reactants or catalysts may be added to the common exhaust of the plasma reactor. This is a beneficial setup, as more reactors in parallel will provide a larger treatment area. In this way, catalysts or co-reactants can be consumed more efficiently.

### Example 2: Reactor Stack Patterns

As shown in FIG. 12, the inventors can increase the capacity of the reactor by 25% by adding one extra reactor module in the flange center (12A). A 6× pattern (12B) can be achieved via a hexagonal reactor alignment (pattern), and 7× (12C) is shown with a reactor in the flange center. The distance between the reactor modules D can vary 1-200 mm and it is determined by the reactors power and heat dissipation. The distance D can be fixed for a regular distribution such as 6×, but it can also be variable per reactor for distributions such as 7×. The reason for this is heat management, as the central reactor module will be subjected to incoming heat from the surrounding reactors modules and will therefore require longer separation distance D than the rest. A further example is given with a scale of 21× (12D).

### Example 3: Gas Conversion

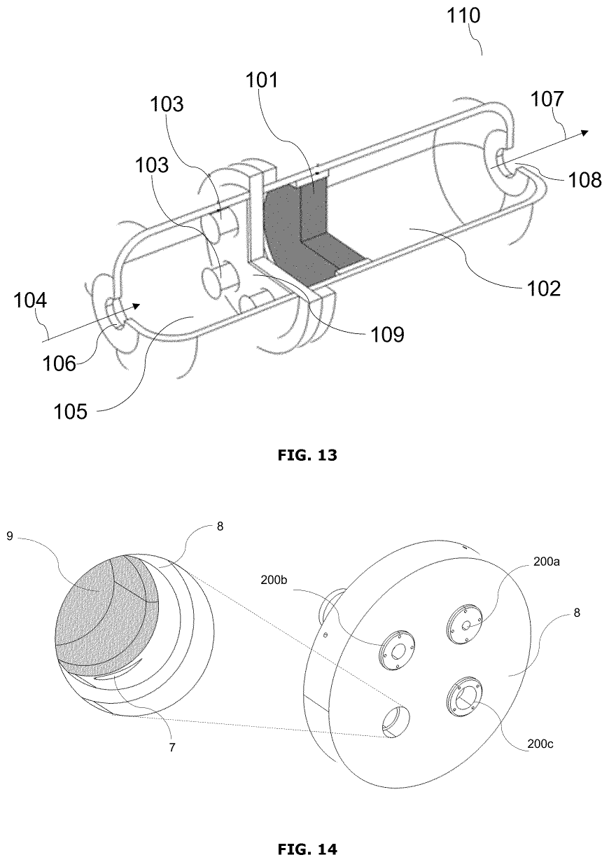

Example 2 relates to a radial reactor stack implemented in a plasma reactor. To better exemplify reference is made to FIG. 13, which shows a cross-sectional view of a fixed bed plasma reactor (110) for the conversion of CO₂ gas. A carbon (101) is added to a processing chamber (102) as a fixed bed, which is positioned downstream to multiple reactor modules (103) arranged in a radial reactor stack (109). The non-reactor modules (103) comprise plasma jet generators that are based on a gliding arc plasma technology, where the multiple gliding arcs are operating in parallel in the reactor stack.

A process gas comprising CO₂ (104) is provided through a gas inlet (106) to the plasma jet generators (103) via a pressure chamber (105). A plasma is ignited in the process gas (104), thereby obtaining a plasma jet comprising CO and O species. The afterglow of the plasma jet is introduced in the processing chamber (102) comprising the carbon bed (101). A product gas (107) is formed comprising decomposition products, which are mainly CO.

The product gas (107) is extracted from the processing chamber (102) through a gas outlet (108).

### Example 4: Interchangeable Outlet Nozzles

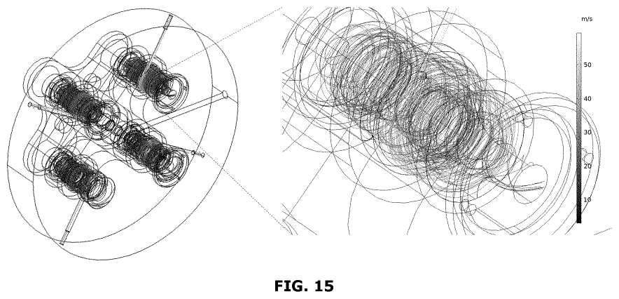

The inventors equipped the reactor modules of a reactor stack with interchangeable outlet nozzles. To better exemplify reference is made to FIG. 14, which shows reactor modules of a reactor stack provided with interchangeable outlet nozzles of 7 mm (200a), 12 mm (200b), and 18 mm (200c), and FIG. 15, which shows a CFD simulation of the reactor stack shown in FIG. 14.

FIG. 14 shows a reactor stack comprising four reactor modules, wherein three reaction chambers are provided with interchangeable outlet nozzles (200). There are three of 7 mm (200a), 12 mm (200b), and 18 mm (200c). The fourth reactor module has no outlet nozzle.

The inventors have found that by equipping the reactor modules of a reactor stack with interchangeable outlet nozzles a reverse-vortex flow pattern is formed, as shown FIG. 15. The high flow velocity (50 m/s) also suggests strong rotation and ability to center and stabilize the plasma.

A pilot reactor stack of 4 reactor modules was built and tested. The reactor modules were powered by 4 1-kW high voltage generators with PWM current control, totaling for 4 kW of combined power. The system was subjected to test the CO₂ to CO conversion, yielding the following results:

| CO₂ Flow rate | | | Energy efficiency |
|---|---|---|---|
| [L/min] | Power [kW] | Conversion [%] | [%] |
| 50 | 4 | 10 | 24 |

The present invention is in no way limited to the embodiments described in the examples and/or shown in the figures. On the contrary, methods according to the present invention may be realized in many different ways without departing from the scope of the invention.

1. A reactor module for converting chemical compounds into materials, gases or energy, wherein the reactor module is suitable for contiguous radial stacking, comprising:
one or more reaction chambers, wherein the one or more reaction chambers have a cylindrical shape characterized by a circular cross-section, wherein said circular cross-section lies in a radial plane, wherein the one or more reaction chambers extend in the axial direction perpendicular to said radial plane, wherein the one or more reaction chambers are connected to an exhaust;
at least one reactant inlet;
wherein said reactor module is characterized by
at least one tangential flow channel, in fluid communication to said at least one reactant inlet, wherein said at least one tangential flow channel is further connected to the one or more reaction chambers tangentially to its circular cross-section, wherein said at least one tangential flow channel is suitable for directing the flow of reactant gas into the one or more reaction chambers.

2. The reactor module according to claim 1, wherein the one or more reaction chambers is are produced from a first electrode and wherein each of the one or more reaction chambers is are further provided with a second electrode, wherein said second electrode is separated from the first electrode with an insulation ring.

3. The reactor module according to claim 2, wherein said second electrode extends axially from said one or more reaction chambers.

4. The reactor module according to claim 1, wherein the one or more reaction chambers comprise plasma generating means, said means chosen from:
gliding arc (GA);
glow discharge;
radiofrequency plasma (RF);
microwave plasma (MW);
inductively coupled plasma (ICP);
capacitive coupled plasma (CCP); or
dielectric barrier discharge (DBD).

5. The reactor module according to claim 1, wherein the reactor module further comprises one or more heat exchange channels suitable for fluid flow therethrough.

6. The reactor module according to claim 1, wherein the reactor module has a cuboid shape.

7. The reactor module according to claim 1, wherein the one or more reaction chambers is are provided with an outlet nozzle.

8. A reactor stack comprising two or more of the reactor modules according to claim 1, contiguously stacked in the radial plane, wherein the reactor stack comprises at least four of the reactor modules, and wherein the at least four reactor modules form a regular polygon pattern.

9. The reactor stack according to claim 8, wherein the reactor stack comprises a common inlet pressure chamber, wherein each reactant inlet of each reactor module is in fluid communication with said common inlet pressure chamber, and wherein said common inlet pressure chamber extends radially.

10. The reactor stack according to claim 8, wherein the reactor stack comprises a common exhaust, and wherein each of the one or more reaction chambers of each reactor module is in fluid communication with said common exhaust extending in the radial plane.

11. The reactor stack according to claim 8, wherein the at least four reactor modules form a square pattern or a hexagonal pattern.

12. A method of using Use of the reactor module according to claim 1 for gas conversion, wherein the gas may be flue gas, waste gas from combustion, CO₂, CO, CH₄, H₂, and any combinations thereof, including impurities.

13. The method according to claim 12, wherein the gas conversion is carried out by plasma generation in the one or more reaction chambers.

14. The method according to claim 12, wherein a flow rate of the reactant gas in each of the one or more reaction chambers is comprised between 0.5 and 5000 L/min.
